(19) United States
(12) Patent Application Publication
(10) Pub. No.: US 2026/0322911 A1
(43) Pub. Date: Oct. 15, 2026

(54) UNIVERSAL CERTIFIED CALL SYSTEM

(71) Applicant: CrowdStrike, Inc., Sunnyvale, CA (US)

(72) Inventor: Prasun Ghosh, Fremont, CA (US)

(21) Appl. No.: 19/179,331

(22) Filed: Apr. 15, 2025

(51) Int. Cl. H04M 1/66; H04L 5/00; H04M 1/57; H04W 12/0431; H04W 12/06

(52) U.S. Cl. CPC H04M 1/66; H04L 5/0053; H04M 1/57; H04W 12/0431; H04W 12/06

(57) ABSTRACT

A method, a device, and non-transitory computer-readable storage medium are directed to indicating whether an incoming call is certified. A user equipment (UE) may receive an incoming call from a caller device and determine whether an indicated caller phone number associated with the incoming call is registered with a token service. Based on determining that the indicated caller phone number is registered with the token service, the UE may transmit to the caller device, an indication of the UE being capable of receiving a certified call and may receive a token from the caller device. The UE may then transmit the indicated caller phone number and the token to the token service for certification of the incoming call. Based on failing to receive communication from the token service, the UE may indicate that the incoming call is uncertified.

### BACKGROUND

Identity theft and phishing attacks have become significant problems in personal and business environments. These attacks often involve fraudulent emails, text messages, phone calls, or websites to obtain sensitive and/or personal information from individuals or businesses. Further, caller ID spoofing makes it difficult for a recipient of an incoming call to trust the caller of the incoming call as appears.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates a timing diagram of an example process for registering a user equipment (UE) running a certification application with a token service.

FIGS. 2 and 3 illustrate a timing diagram of an example process for accepting a call from a certified caller by the UE running the certification application.

FIGS. 4 and 5 illustrate a timing diagram of an example process for indicating an incoming call as an uncertified call by the UE running the certification application.

FIGS. 6 and 7 illustrate a timing diagram of an example process for rejecting a call from a caller device by the UE with a copied identity running the certification application.

FIGS. 8 and 9 illustrate a flowchart of an example process for managing a call from a caller device by the UE running the certification application.

FIG. 10 illustrates a block diagram of an example certification system including a caller device, a UE, and a token service.

### DETAILED DESCRIPTION

Currently available solutions for preventing such attacks generally rely on personal identification information but are often inadequate. A business organization may utilize pre-arranged security questions or codes to verify identities of callers to prevent, or at least reduce, such attacks. For example, authentication methods often require a user to provide sensitive information, such as the last four digits of his social security number (SSN), the date of birth, or answers security questions. However, these information can be compromised, forgotten, or lost, and the act of providing the information creates opportunities for the attackers to capture the information, which can be used in future fraudulent activities by the attackers. While there are some proposed solutions to address the shortcomings noted above, these solutions require significant changes to existing telephone network infrastructure, making them costly and challenging to implement on a large scale.

This disclosure describes, in part, a method and system for accepting a certified call based on a temporary token confirmed by a token service and/or rejecting an uncertified call and/or a suspected phishing call based on lack of the temporary token or an unconfirmed identify of the caller.

For example, a user equipment (UE) may receive an incoming call from a caller device and determine whether an indicated caller phone number associated with the incoming call is registered with a token service. Based on determining that the indicated caller phone number is registered with the token service, the UE may transmit to the caller device, an indication of the UE being capable of receiving a certified call and may receive a token from the caller device. The UE may then transmit the indicated caller phone number and the token to the token service for certification of the incoming call. Based on failing to receive an acknowledgement (ACK) from the token service, the UE may indicate that the incoming call is uncertified.

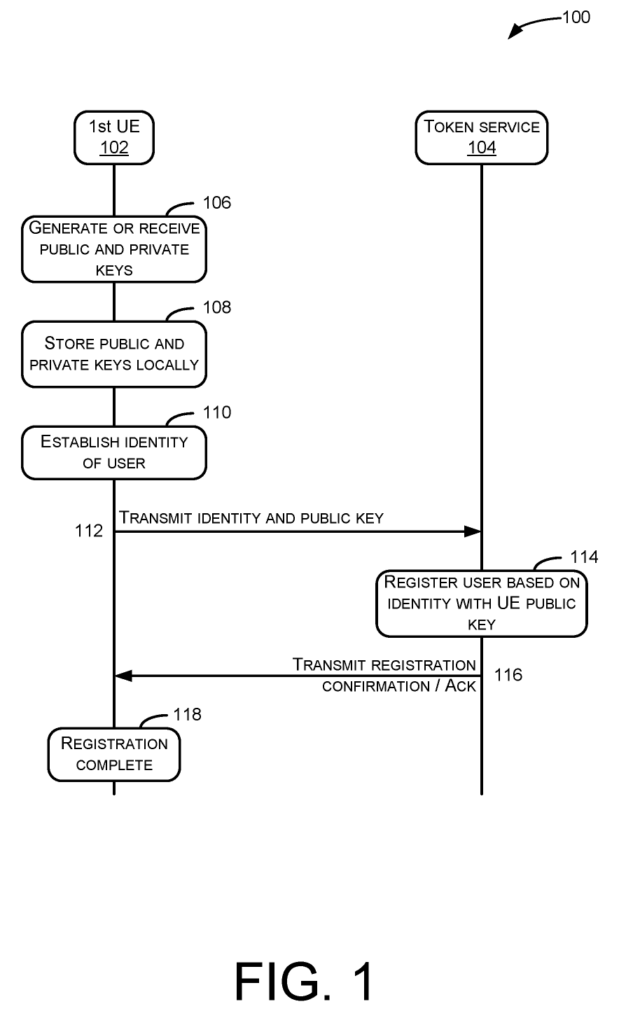

FIG. 1 illustrates a timing diagram 100 of an example process for registering a first user of a first user equipment (UE) 102 with a token service 104. The first user may utilize a certification application on the first UE 102 to perform the registration process with the token service 104 upon installing the certification application to the first UE 102. More specifically, one or more processors (processors) of the first UE 102 may execute the certification application installed on the first UE 102 and perform the registration process with the token service 104. Communications between the first UE 102 and the token service 104 may be conducted through a secure channel or connection, such as Hypertext Transfer Protocol Secure (https) communication. The first UE 102 may generate, or receive from the token service 104, a public key (a first UE public key) and a private key (a first UE private key) at step 106, and store the first UE private key and the UE public key in a local database of the first UE 102 at step 108. For example, the first UE public key and the first UE private key may be generated based on one or more of Public Key Cryptography Standards (PKCS) by the first UE 102 or the token service 104.

At step 110, the first UE 102 may establish a first identity of the first user based on identification information associated with the first user, such as a first UE phone number of the first UE 102, the passport number of the first user, the driver’s license number of the first user, the social security number of the first user, and/ or other government issued identification of the first user. The first UE 102 may then transmit the first identity of the first user along with the first UE public key for registering the first user with the token service 104 at step 112. At step 114, the token service 104 may receive the first identity along with the first UE public key and register the first user based on the first identity with the UE public key, for example, by storing the first identity in a token database of the token service 104. In response to registering the first user, the token service 104 may transmit a registration confirmation, or an acknowledgment (Ack), to the first UE 102 at step 116, and the first UE 102 may receive the Ack and complete the registration at step 118. Additionally, any user or entity with a communication device utilizing the certification application may similarly register with the token service 104 with corresponding public and private keys for certified communication with other registered users. For example, a group of the first user’s relatives, friends, and/or businesses associated with the first user may utilize the certification application and register with the token service 104 to avoid receiving and/or answering fake calls that appear to be from family members, friends, and/or associates of the first user.

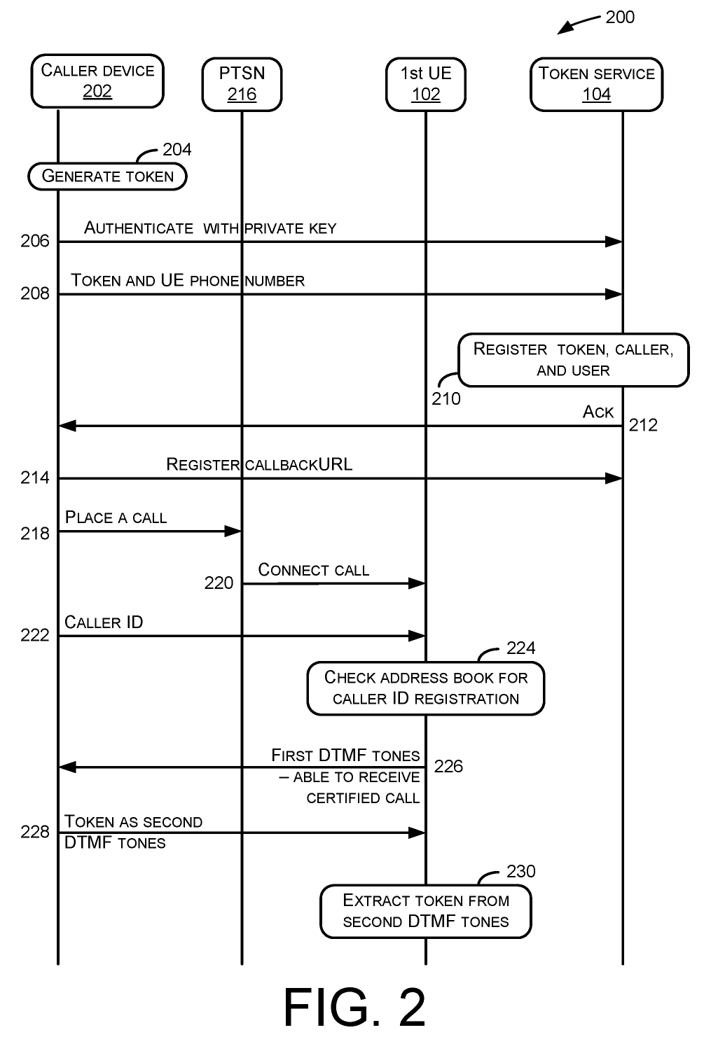

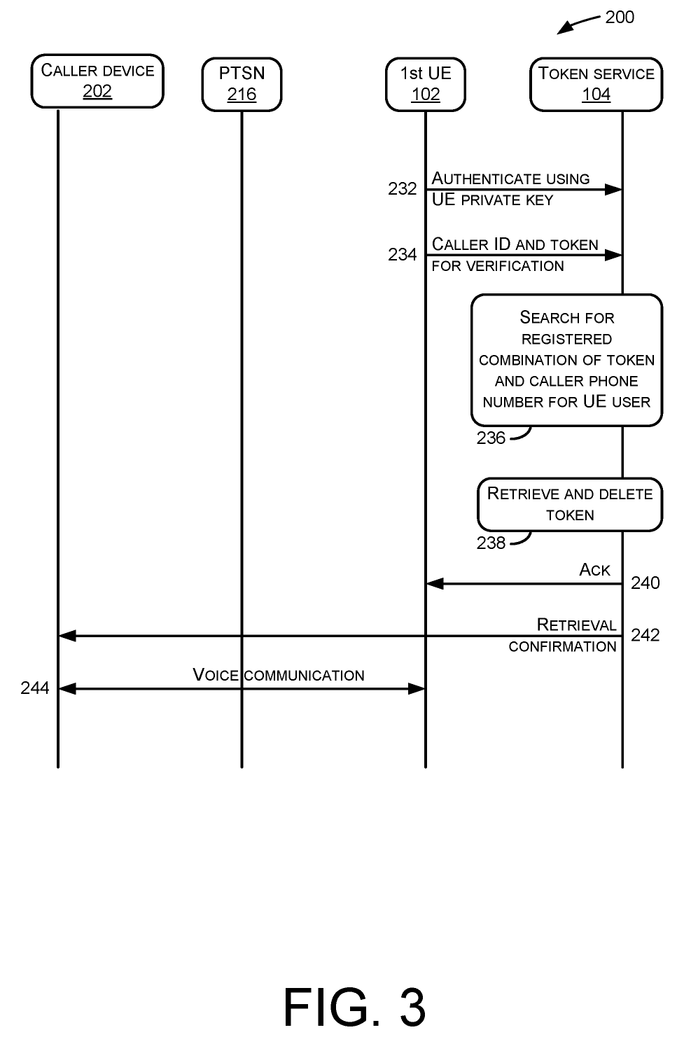

FIGS. 2 and 3 illustrate a timing diagram 200 of an example process for accepting a certified incoming call from a caller device 202 by a UE, such as the first UE 102 running the certification application. In this example, a caller of the caller device 202, with a caller phone number and running the certification application installed, has completed the registration process as described above with reference to FIG. 1, and is registered with the token service 104. Communications between the token service 104 and the first UE 102 and between the token service 104 and the caller device 202 may be made utilizing the https communication technique.

At step 204, the caller device 202 may generate a token for a call targeting the first UE phone number. At step 206, the caller device 202 may authenticate the caller to the token service 104 by way of using a caller private key stored in the caller device 202 and a caller public key stored in the token data base of the token service 104. At step 208, the caller device 202 may transmit the token and the first UE phone number for registering the call with the token service 104. The token may be a unique number having a preselected digits, for example, a 10 digit number, such as 1234567890, or other number of digits preselected by the certification application. The token may also include an expiration period, and expire and/or become invalid after the expiration period. The expiration period may be any reasonable length in time appropriate for the call certification process described in this disclosure, such as, but not limited to, 5 to 60 seconds. At step 210, the token service 104 may register the token targeting the first UE phone number, the caller, and the first user, for example, by storing registration information of the call in the token database of the token service 104, and send an acknowledge (Ack) of registration to the caller device 202 at step 212. The expiration period, 30 seconds for example, may start upon the token service 104 registering the token at step 210. The caller device 202, in response to receiving the Ack, may register a callback Uniform Resource Locator (callbackURL) with the token service 104 for confirming the token retrieval at step 214. Alternatively, the callback URL of step 214 may be passed at step 208 along with the token and the first UE phone number. Additionally, and/or alternatively, if the caller device 202 does not receive the Ack, such as within a predetermined time, the caller device 202 may destroy the callbackURL that the caller device 202 intends to use. The predetermined time may be the same as, or different from the expiration period of the token.

The caller device 202 may then place a call to the first UE 102 using the first UE phone number by way of a public switched telephone network (PTSN) 216 at step 218, and the PTSN 216 may connect the call to the first UE 102 at step 220. Based on the call being connected, the caller device 202 may indicate the caller phone number of the caller device 202, for example, by way of the caller ID process of a normal phone call, to the first UE 102 at step 222. At step 224, the first UE 102 may check a local database of the first UE 102, such as an address book or a contact list of the first UE 102, or the token database of the token service 104, to determine whether the caller ID, i.e., the indicated caller phone number by the caller device 202, is registered with the token service 104. For example, the caller phone number may be listed in the address book as a registered number with the token service 104. Based on determining that the caller phone number is registered with the token service 104, the first UE 102 may transmit a first series of dual tone multi-frequency (DTMF) tones to the caller device 202 to indicate that the first UE 102 is capable of receiving a certified call at step 226. In response, the caller device 202 may transmit the token to the first UE 102 as a second series of DTMF tones at step 228. At step 230, the first UE 102 may receive the second series of DTMF tones and extract the token from the second series of DTMF tones. The first UE 102 may then authenticate the first user to the token service 104 by way of using the first UE private key stored in the first UE 102 and the first UE public key stored in the token database of the token service 104 at step 232. The first UE 102 may transmit the caller ID, i.e., the caller phone number, and the token to the token service 104 for certification at step 234. Alternatively, step 232 and step 234 may be merged into a single step.

The token service 104 may search for a registered combination of the token and the caller phone number and/or the caller, where the registered combination is associated with the first UE user, in the token database at step 236. Upon finding the registered combination, the token service 104 may retrieve and delete the token from the token database at step 238. The token service 104 may transmit an Ack to the first UE 102 to confirm authenticity of the call at step 240, and transmit a confirmation of retrieving the token to the caller device 202 using the callbackURL at step 242. The caller device 202 and the first UE 102 may begin voice communication at step 244.

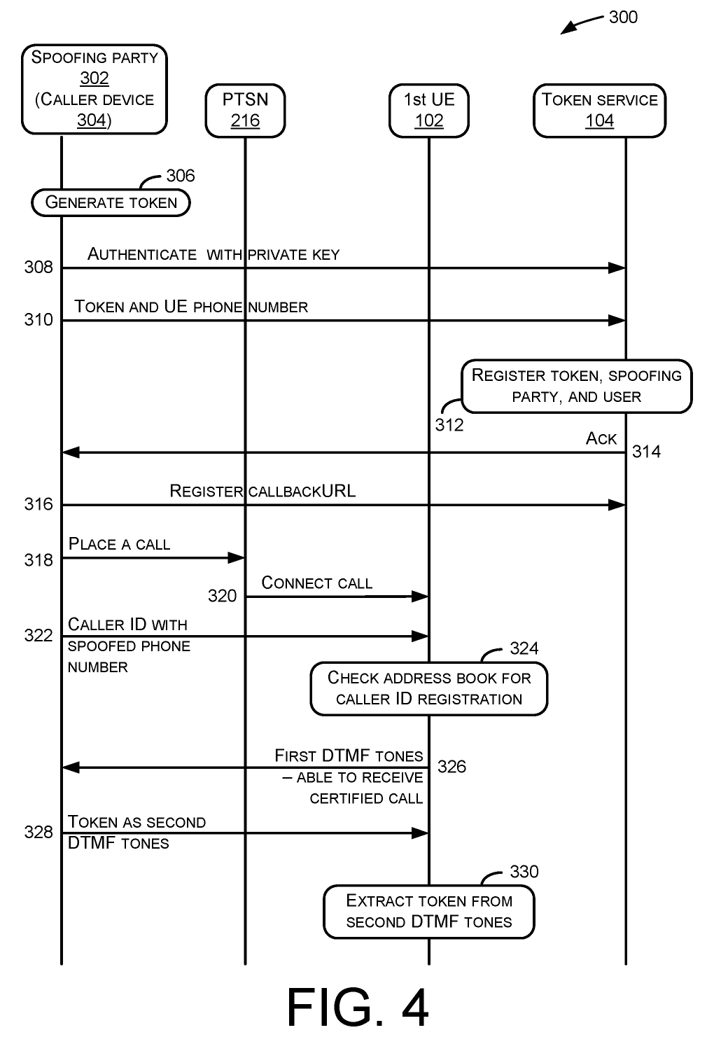

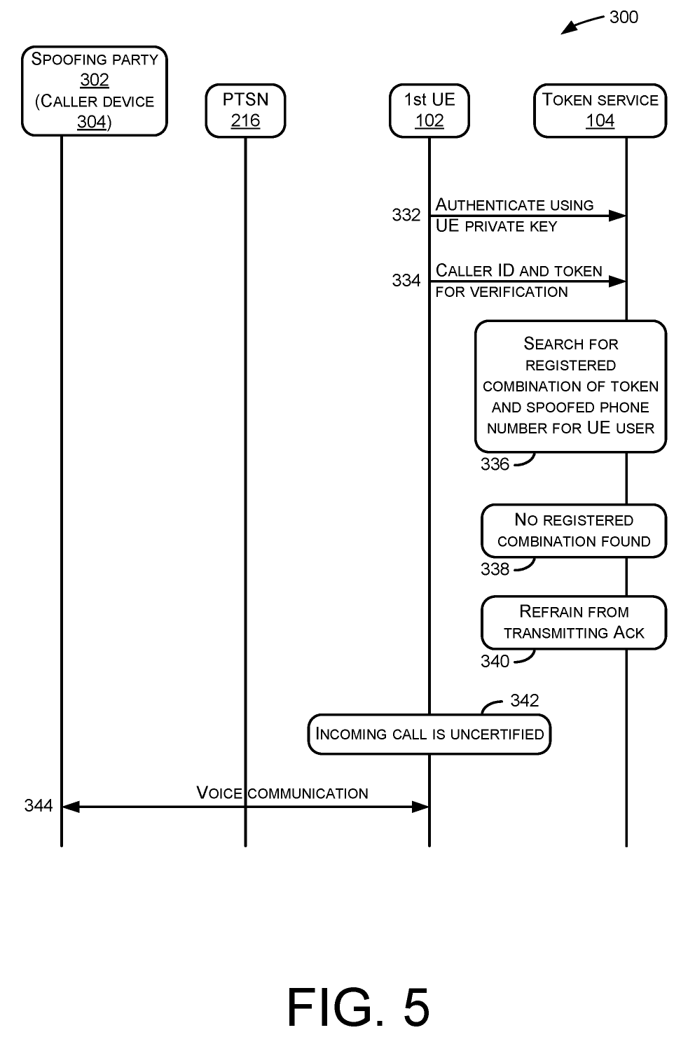

FIGS. 4 and 5 illustrate a timing diagram 300 of an example process for indicating an incoming call as an uncertified call by the first UE 102 running the certification application. For example, a caller originating the incoming call may be a spoofing party 302 using a spoofed phone number, instead of a caller phone number assigned to the spoofing party 302, to falsely present itself as a known party of the first user of the first UE 102. As described above with reference to FIG. 1, the spoofing party 302 may utilize the certification application and may have completed the registration process with the token service 104. Communications between the token service 104 and the first UE 102 and between the token service 104 and a caller device 304 of the spoofing party 302 may be made utilizing the https communication technique.

At step 306, the caller device 304 of the spoofing party 302 may generate a token for a call targeting the first UE phone number. At step 308, the caller device 304 may authenticate the spoofing party 302 to the token service 104 by way of using a caller private key stored in the caller device 304 and a caller public key stored in the token database of the token service 104.

At step 310, the caller device 304 may transmit the token and the first UE phone number for registering the call with the token service 104. The token may be a unique number having a preselected digits, for example, a 10 digit number, such as 1234567890, or other number of digits preselected by the certification application. The token may also include an expiration period, and expire and/or become invalid after the expiration period. The expiration period may be any reasonable length in time appropriate for the call certification process described in this disclosure, such as, but not limited to, 5 to 60 seconds. At step 312, the token service 104 may register the token targeting the first UE phone number, the spoofing party 302, and the first user, for example, by storing registration information of the call in the token database of the token service 104, and send an acknowledge (Ack) of registration to the caller device 304 at step 314. The expiration period, 30 seconds for example, may start upon the token service 104 registering the token at step 312. The caller device 304, in response to receiving the Ack, may register a callback Uniform Resource Locator (callbackURL) with the token service 104 for confirming the token retrieval at step 316. Alternatively, the callback URL of step 316 may be passed at step 310 along with the token and the first UE phone number. Additionally, and/or alternatively, if the caller device 304 does not receive the Ack within a predetermined time, the caller device 304 may destroy the callbackURL that the caller device 304 intends to use. The predetermined time may be the same as, or different from the expiration period of the token.

The caller device 304 may then place a call to the first UE 102 using the first UE phone number by way of the PTSN 216 at step 318, and the PTSN 216 may connect the call to the first UE 102 at step 320. Based on the call being connected, the caller device 304 may indicate a spoofed phone number, for example, by way of the caller ID process, to the first UE 102 at step 322. At step 324, the first UE 102 may check a local database of the first UE 102, such as an address book or a contact list of the first UE 102, or the token database of the token service 104, to determine whether the caller ID, i.e., the indicated phone number (the spoofed phone number) by the caller device 304, is registered with the token service 104. For example, the spoofed phone number may be a phone number of a friend of the first user of the first UE 102 listed in the address book as a registered number with the token service 104. Based on determining that the spoofed phone number is registered with the token service 104, the first UE 102 may transmit a first series of dual tone multi-frequency (DTMF) tones to the caller device 304 to indicate that the first UE 102 is capable of receiving a certified call at step 326. In response, the caller device 304 may transmit the token to the first UE 102 as a second series of DTMF tones at step 328. At step 330, the first UE 102 may receive the second series of DTMF tones and extract the token from the second series of DTMF tones. The first UE 102 may then authenticate the first user to the token service 104 by way of using the first UE private key stored in the first UE 102 and the first UE public key stored in the token database of the token service 104 at step 332. The first UE 102 may transmit the caller ID, i.e., the spoofed phone number, and the token to the token service 104 for certification at step 334. Alternatively, step 332 and step 334 may be merged into a single step.

The token service 104 may search for a registered combination of the token and the spoofed phone number and/or a true owner of the spoofed phone number, where the registered combination is associated with the first UE user, in the token database at step 336. Because the spoofing party 302 has registered the token for this call targeting the first UE phone number with the authenticated identity of the spoofing party 302, there is no registration of the true owner of the spoofed phone number for this call in the token database. Consequently, the token service 104 would fail to find the registered combination of the token, the true owner of the spoofed phone number, and the first UE user in the token database at step 338. Upon failing to find the registered combination, the token service 104 may take no further action associated with the incoming call, i.e., refrain from transmitting communication, such as an acknowledgement (Ack) to the first UE 102, at step 340, and the first UE 102 may indicate, for example, by displaying a message or audibly indicating that, the incoming call is uncertified, i.e., the incoming call is a spoofed call, at step 342 after failing to receive the Ack within a predetermined time, such as, but not limited to, five seconds. Alternatively, the token service 104 may transmit a negative acknowledgment (Nack) upon failing to find the registered combination. With the indication, or a warning, that the incoming call is a spoofed call, the first user of the first UE 102 may terminate the uncertified incoming call. The first user may also configure the first UE 102 to automatically reject a spoofed call. However, the certification application of the first UE 102 may also allow the first user of the first UE 102 to start voice communication between the caller device 304 of the spoofing party 302 and the first UE 102 as shown at step 344.

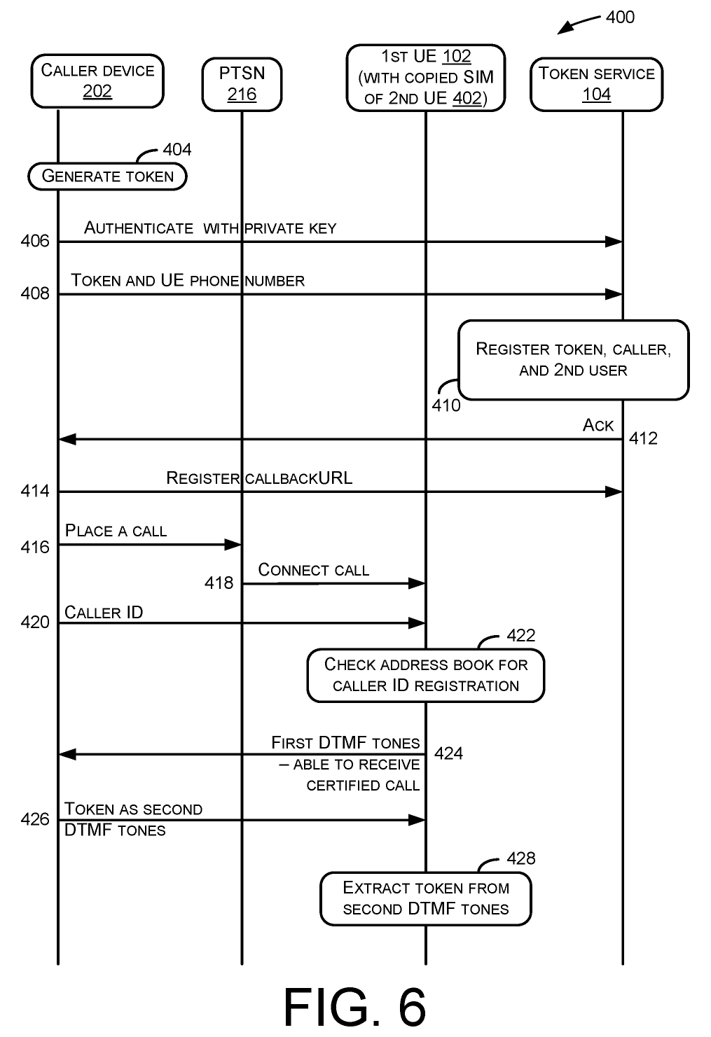

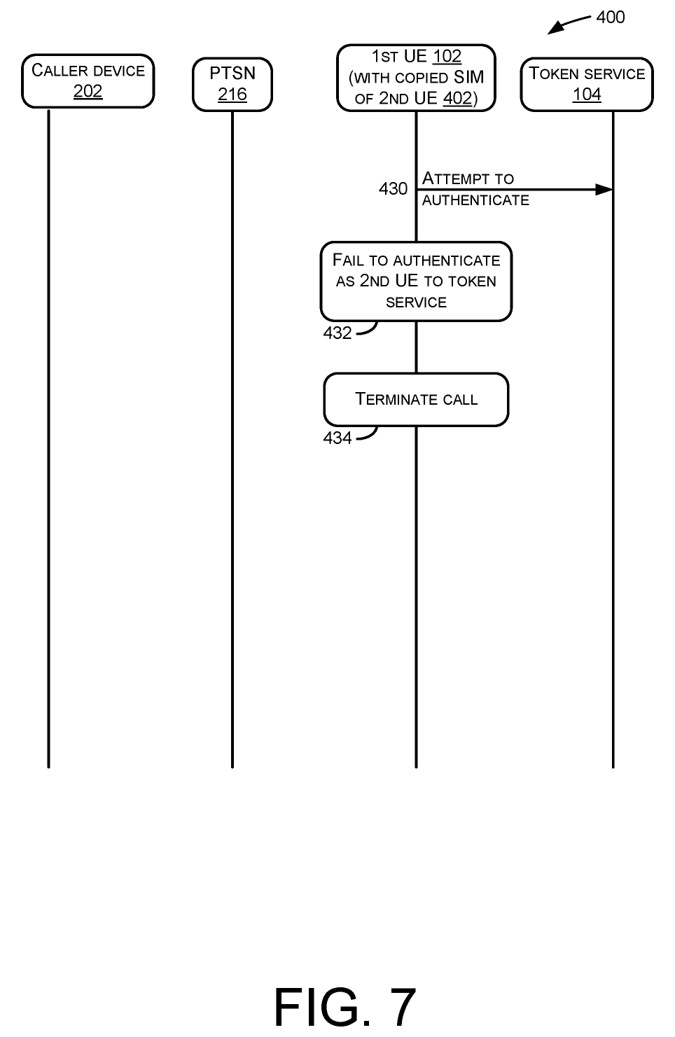

FIGS. 6 and 7 illustrate a timing diagram 400 of an example process for rejecting an incoming call from a caller device, such as the caller device 202 by the first UE 102, with a copied identity of a second UE 402, running the certification application. For example, the first UE 102 may be operating with a copied subscriber identity module (SIM) of the second UE 402 having a second UE phone number. However, the first UE 102 may have completed the registration process with the identity of the first UE 102 and registered with the token service 104 as described above with reference to FIG. 1. In this example, the caller device 202, with the caller phone number and running the certification application installed, has completed the registration process as described above with reference to FIG. 1, and is registered with the token service 104. Communications between the token service 104 and the first UE 102 and between the token service 104 and the caller device 202 may be made utilizing the https communication technique.

At step 404, the caller device 202 may generate a token for a call targeting the second UE 402. At step 406, the caller device 202 may authenticate the caller to the token service 104 by way of using a caller private key of the caller device 202 stored in the caller device 202 and a caller public key stored in the token data base of the token service 104. At step 408, the caller device 202 may transmit the token and the second UE phone number for registering the call with the token service 104. The token may be a unique number having a preselected digits, for example, a 10 digit number, such as 1234567890, or other number of digits preselected by the certification application. The token may also include an expiration period, and expire and/or become invalid after the expiration period. The expiration period may be any reasonable length in time appropriate for the call certification process described in this disclosure, such as, but not limited to, 5 to 60 seconds. At step 410, the token service 104 may register the token targeting the second UE phone number, the caller, and the second user, for example, by storing registration information of the call in the token database of the token service 104, and send an acknowledge (Ack) of registration to the caller device 202 at step 412. The expiration period, 30 seconds for example, may start upon the token service 104 registering the token at step 410. The caller device 202, in response to receiving the Ack, may register a callback Uniform Resource Locator (callbackURL) with the token service 104 for confirming the token retrieval at step 414. Alternatively, the callback URL of step 414 may be passed at step 408 along with the token and the second UE phone number. Additionally, and/or alternatively, if the caller device 202 does not receive the Ack within a predetermined time, the caller device 202 may destroy the callbackURL that the caller device 202 intends to use. The predetermined time may be the same as, or different from the expiration period of the token.

The caller device 202 may then place a call to the second UE phone number by way of a public switched telephone network (PTSN) 216 at step 416, and the PTSN 216 may connect the caller device 202 to the first UE 102 instead of the second UE 402, at step 418, because the first UE 102 is operating with the copied SIM and presenting the first UE 102 as the second UE 402. Based on the call being connected, the caller device 202 may indicate the caller phone number of the caller device 202, for example, by way of the caller ID process of a normal phone call, to the first UE 102 at step 420. At step 422, the first UE 102 may check a local database of the first UE 102, such as an address book or a contact list of the first UE 102, or the token database of the token service 104, to determine whether the caller ID, i.e., the indicated caller phone number by the caller device 202, is registered with the token service 104. For example, the caller phone number may be listed in the address book as a registered number with the token service 104. Based on determining that the caller phone number is registered with the token service 104, the first UE 102 may transmit a first series of dual tone multi-frequency (DTMF) tones to the caller device 202 to indicate that the first UE 102 is capable of receiving a certified call at step 424. In response, the caller device 202 may transmit the token to the first UE 102 as a second series of DTMF tones at step 426. At step 428, the first UE 102 may receive the second series of DTMF tones and extract the token from the second series of DTMF tones, and attempt to authenticate the first user to the token service 104 at step 430. However, while the first UE 102 is operating with the copied SIM and presenting itself as the second UE 402, the first UE 102 does not have a second UE private key of the second UE 402. Consequently, the first UE 102 may fail to authenticate the first user as the second user to the token service 104 at step 432, and the first UE 102 may terminate the call at step 434.

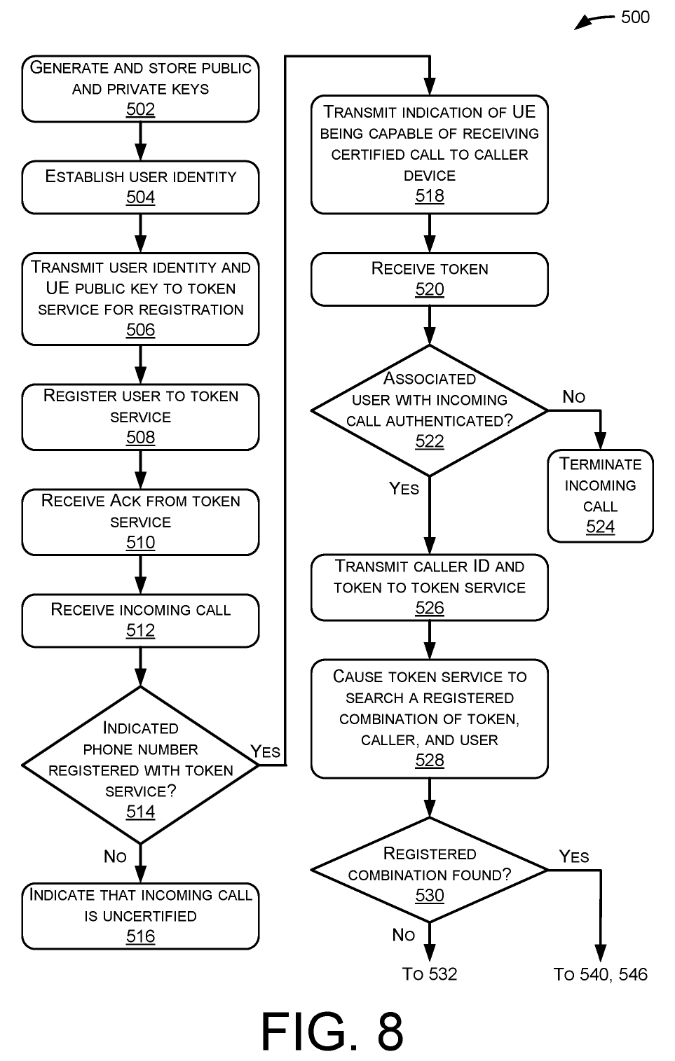

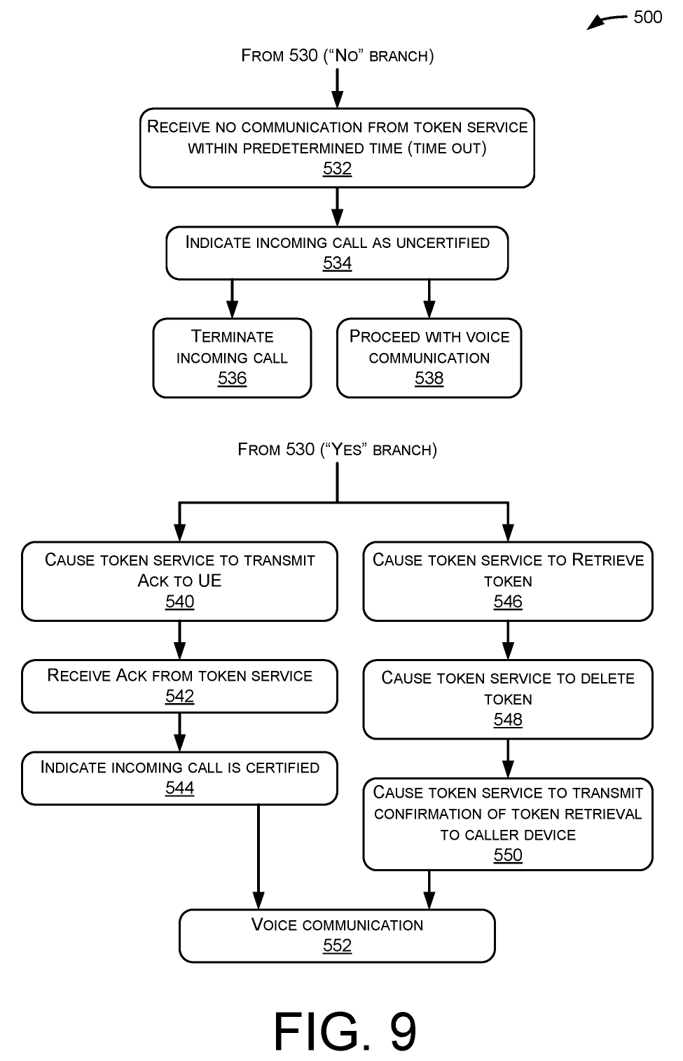

FIGS. 8 and 9 illustrate a flowchart 500 of an example process for managing a call from a caller device, such as the caller device 202, by the first UE 102 running the certification application. As described above with reference to FIG. 1, the first user of the first UE 102 may register with the token service 104 upon installing the certification application. The example process below is described from a perspective of the first UE 102, and more specifically, one or more processors of the first UE 102 performing operations described below by executing the certification application installed in the first UE 102.

At block 502, the first UE 102 may generate, or receive from the token service 104, a public key (a first UE public key) and a private key (a first UE private key) and store the first UE private key and the first UE public key in a local database of the first UE 102. For example, the first UE public key and the first UE private key may be generated based on one or more of Public Key Cryptography Standards (PKCS) by the first UE 102 or the token service 104. At block 504, the first UE 102 may establish a first identity of the first user based on identification information associated with the first user, such as a first UE phone number of the first UE 102, the passport number of the first user, the driver’s license number of the first user, the social security number of the first user, and/ or other government issued identification of the first user. The first UE 102 may then transmit the first identity of the first user along with the first UE public key for registering the first user with the token service 104 at block 506, and register with the token service 104, or cause the token service 104 to register, the first user based on registration information including the first identity of the first user with the first UE public key at block 508. For example, the token service 104 may store the registration information in a token database of the token service 104. At block 510, the first UE 102 may receive a registration confirmation, or an acknowledgment (Ack) from the token service 104, and complete the registration. Additionally, any communication device utilizing the certification application may similarly register with the token service 104 to be able to communicate with other registered and certified communication devices. For example, a group of UEs and communication devices, such as UEs of the user’s relatives and friends and communication devices of businesses associated with the user, may utilize the certification application, and register with the token service 104 to avoid receiving and/or answering fake calls that appear to be from family members, friends, and/or associates of the user. At block 512, the first UE 102 may receive a call, or an incoming call, from the caller device 202.

As described above with reference to FIGS. 2, 4, and 6, prior to placing the call, the caller device 202 has generated a token for the call targeting the first UE phone number and has authenticated the caller of the caller device 202 to the token service 104 using a caller private key of the caller device 202 stored in the caller device 202. The token may be a unique number having a preselected digits, include an expiration period, and expire and/or become invalid after the expiration period. In response to receiving acknowledgement (Ack) from the token service 104, the caller device 202 has registered a callback Uniform Resource Locator (callbackURL) with the token service 104 for confirming the token retrieval.

At block 514, the first UE 102 may determine whether an indicated caller phone number associated with the incoming call is registered with the token service 104. The indicated caller phone number may be provided to the first UE 102 by way of the caller ID. For example, the first UE 102 may check a local database of the first UE 102, such as an address book or a contact list of the first UE 102, or the token database of the token service 104, for the indicated caller phone number. Based on determining that the indicated caller phone number is not registered with the token service 104 (“No” branch), the first UE 102 may indicate that the incoming call is not certified at block 516, for example, by displaying a message “Uncertified Call.” The user of the first UE 102 may, knowing that the incoming call is uncertified, answer or terminate the incoming call.

Based on determining that the indicated caller phone number is registered with the token service 104 (“Yes” branch) at block 514, the first UE 102 may transmit an indication of the first UE 102 being capable of receiving a certified call to the caller device 202 at block 518. The first UE 102 may transmit the indication to the caller device 202 as a first series of dual tone multi-frequency (DTMF) tones. At block 520, the first UE 102 may receive the token from the caller device 202 as a second series of DTMF tones, and extract the token from the second series of DTMF tones. The first UE 102 may first authenticate an associated user with the incoming call to the token service 104 before submitting the token and the indicated caller phone number for certification determination.

At block 522, the first UE 102 may determine whether the associated user with the incoming call is authenticated. For example, if the associated user with the incoming call is the first user, the identity of the first user can be authenticated with the first UE private key stored in the first UE 102. However, if the first UE 102 is operating with a copied SIM of a second UE, such as the second UE 402 as described above with reference to FIGS. 6 and 7, and the incoming call is directed to a second user of the second UE 402, i.e., a second UE phone number of the second UE 402, but is connected to the first UE 102 with the copied SIM, then an identity of the second user is not authenticated with the first UE private key stored in the first UE 102. Based on the identity of the associated user not being authenticated (“No” branch), the first UE 102 may terminate the incoming call at block 524. Based on the associated user being authenticated (“Yes” branch), that is, the associated user is the first user and is authenticated with the first UE private key, the first UE 102 may transmit the caller ID, i.e., the indicated caller phone number, and the token to the token service 104 at block 526.

At block 528, the token service 104 may search, or may be caused to search, for a registered combination of the token, the indicated caller phone number, and the user in the token database. For example, if the indicated caller phone number is spoofed, that may imply that the caller has registered the token for this call targeting the first UE phone number with the authenticated identity of the caller and not with an identity associated with spoofed phone number. Then there would be no registration of a true owner of the spoofed phone number for this call in the token database. Consequently, the token service 104 would fail to find the registered combination of the token, the true owner of the spoofed phone number, and the first UE user in the token database. At block 530, the token service 104 may determine, or may be caused to determine, whether the registered combination is found. Based on the token service 104 failing to find the combination (“No” branch), the token service 104 may take, or may be caused to take, no further action associated with the incoming call. Based on failing to receive communication, such as an Ack, back from the token service 104 within a predetermined time (time out) at block 532, the first UE 102, may indicate that the incoming call is uncertified at block 534, for example, by displaying, audibly playing, a message. The first user of the first UE 102 may choose to terminate the uncertified incoming call at block 536 or choose to proceed with a voice communication as allowed by the certification application of the first UE 102 at block 538.

Based on the token service 104 finding the combination (“Yes” branch), the token service 104 may transmit, or may be caused to transmit, an acknowledgement (Ack) to the first UE 102 at block 540, and the first UE 102 may receive the Ack from the token service 104 at block 542. The first UE 102 may indicate that the incoming call is certified at block 544. Based on the token service 104 finding the combination (“Yes” branch), the token service 104 may also retrieve, or may be caused to retrieve, the token from the token database at block 546, and may delete, or may be caused to delete, the token from the token database at block 548. At block 550, the token service 104 may transmit, or may be caused to transmit a confirmation of retrieving the token to the caller device 202. At block 552, the first UE 102 may begin voice communication with the caller device 202.

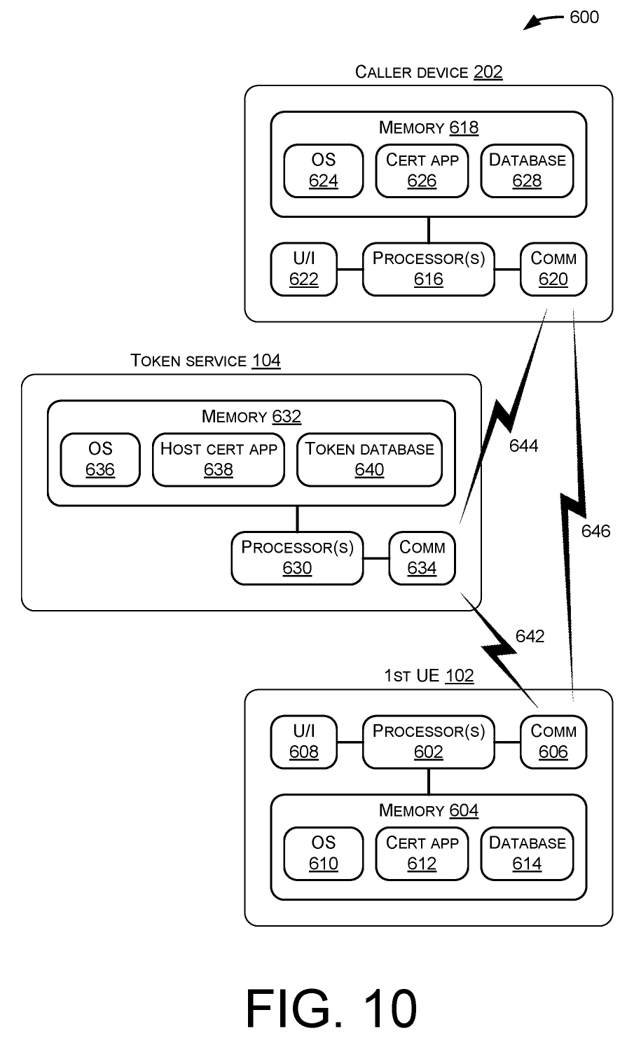

FIG. 10 illustrates a block diagram 600 of an example certification system including a UE, such as the first UE 102, a caller device, such as the caller device 202, and a token service, such as the token service 104. The first UE 102 may be a cellular mobile communication device, an IP phone, a computer, or any other communication device capable of supporting the processes as described above with reference to FIGS. 1-9. The first UE 102 may include one or more processors (processors) 602 communicatively coupled to memory 604, a communication module 606, and a user interface (U/I) 608. The processors 602 may execute computer-readable instructions stored in the memory 604 and perform operations described above with reference to FIGS. 1-9. For example, the memory 604 may include an operating system (OS) 610 for managing hardware and software associated with the first UE 102, the certification application 612 for registering the first user of the first UE 102 and certifying incoming calls, and a database 614 for storing data including the first UE private key, the first UE public key, and the address book or the contact list, as described above with reference to FIGS. 1-9. The communication module 606 may be utilized to communicate with token service 104 and the caller device 202, and the U/I 608 may be utilized to enter the identification information associated with the first user and to display the caller ID of the incoming call and whether the incoming call is certified, as described above with reference to FIGS. 1-9.

The caller device 202 may be the same type of a device as, or at least similar in functionality to, the first UE 102. The caller device 202 may a cellular mobile communication device, an IP phone, a computer, or any other communication device capable of supporting the processes as described above with reference to FIGS. 1-9. The caller device 202 may include one or more processors (processors) 616 communicatively coupled to memory 618, a communication module 620, and a user interface (U/I) 622. The processors 616 may execute computer-readable instructions stored in the memory 618 and perform operations described above with reference to FIGS. 1-9. For example, the memory 618 may include an operating system (OS) 624 for managing hardware and software associated with the caller device 202, the certification application 626 for registering the caller of the caller device 202 and generating the token for calls to be certified, and a database 628 for storing data including the caller private key and the caller public key as described above with reference to FIGS. 1-9.

The token service 104 may include one or more processors (processors) 630 communicatively coupled to memory 632 and a communication module 634. The processors 630 may execute computer-readable instructions stored in the memory 632 and perform operations described above with reference to FIGS. 1-9. For example, the memory 632 may include an operating system (OS) 636 for managing hardware and software associated with the token service 104, a host certification application 638, and a token database 640 for storing data including the UE public key, the caller public key, tokens, registration information, and other data as described above with reference to FIGS. 1-9. The token service 104 may also be hosted within a cloud.

Communications between the first UE 102 and the token service 104 may be performed by the communication modules 606 and 634 as shown by communication 642, communications between the caller device 202 and the token service 104 may be performed by the communication modules 620 and 634 as shown by communication 644, and communications between the first UE 102 and the caller device 202 may be performed by the communication modules 606 and 620 as shown by communication 646. While the communications 642, 644, and 646, are shown as wireless communications over a wireless network, such as a cellular communication network, a wireless local area network (WLAN), a Bluetooth network, and the like, the communications 642, 644, and 646 may also be conducted over a wireline network, such as a landline telephone network, an Ethernet network, a cable network, the Internet, and other wireline networks, or any combination of the wireless and wireline networks.

Some or all operations of the methods described above can be performed by execution of computer-readable instructions stored on a computer-readable storage medium, as defined below. The terms “computer-readable medium,” “computer-readable instructions,” “computer-executable instructions,” and “processor-executable instructions” as used in the description and claims, include routines, applications, application modules, program modules, programs, components, data structures, algorithms, and the like. Computer-readable and -executable instructions and processor-executable instructions can be implemented on various system configurations, including single-processor or multiprocessor systems, minicomputers, mainframe computers, personal computers, hand-held computing devices, microprocessor-based, programmable consumer electronics, combinations thereof, and the like.

The computer-readable storage media may include volatile memory (such as random-access memory (RAM)) and/or non-volatile memory (such as read-only memory (ROM), flash memory, etc.). The computer-readable storage media may also include additional removable storage and/or non-removable storage including, but not limited to, flash memory, magnetic storage, optical storage, and/or tape storage that may provide non-volatile storage of computer-readable instructions, data structures, program modules, and the like.

A non-transitory computer-readable storage medium is an example of computer-readable media. Computer-readable media includes at least two types of computer-readable media, namely computer-readable storage media and communications media. Computer-readable storage media includes volatile and non-volatile, removable and non-removable media implemented in any process or technology for storage of information such as computer-readable instructions, data structures, program modules, or other data. Computer-readable storage media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In contrast, communication media may embody computer-readable instructions, data structures, program modules, or other data in a modulated data signal, such as a carrier wave, or other transmission mechanism. As defined herein, computer-readable storage media do not include communication media.

The computer-readable instructions, such as the certification application 612, stored on one or more non-transitory computer-readable storage media, such as the memory 604, when executed by one or more processors, such as the processors 602, may perform operations described above with reference to FIGS. 1-9. Generally, computer-readable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the processes.

Unless explicitly excluded, the use of the singular to describe a component, structure, or operation does not exclude the use of plural such components, structures, or operations or their equivalents. The use of the terms "a" and "an" and "the" and "at least one" or the term "one or more," and similar referents in the context of describing the invention (especially in the context of the following claims) are to be construed to cover both the singular and the plural, unless otherwise indicated herein or clearly contradicted by context. The use of the term "at least one" followed by a list of one or more items (for example, "at least one of A and B" or one or more of A and B") is to be construed to mean one item selected from the listed items (A or B) or any combination of two or more of the listed items (A and B; A, A and B; A, B and B), unless otherwise indicated herein or clearly contradicted by context. Similarly, as used herein, the word "or" refers to any possible permutation of a set of items. For example, the phrase "A, B, or C" refers to at least one of A, B, C, or any combination thereof, such as any of: A; B; C; A and B; A and C; B and C; A, B, and C; or multiple of any item such as A and A; B, B, and C; A, A, B, C, and C; etc.

Although the subject matter has been described in language specific to structural features and/or methodological acts, it is to be understood that the subject matter defined in the appended claims is not necessarily limited to the specific features or acts described. Rather, the specific features and acts are disclosed as exemplary forms of implementing the claims.

What is claimed is:

1. A method performed by a user equipment (UE) comprising:
receiving an incoming call from a caller device;
determining whether an indicated caller phone number associated with the incoming call is registered with a token service;
based on determining that the indicated caller phone number is registered with the token service, transmitting, to the caller device, an indication of the UE being capable of receiving a certified call;
receiving a token from the caller device;
transmitting the indicated caller phone number and the token to the token service; and
based on failing to receive communication from the token service, indicating that the incoming call is uncertified.

2. The method of claim 1, wherein:
a caller of the caller device is authenticated with the token service using a caller private key associated with the caller;
the token is generated by the caller device for a UE phone number associated with a user of the UE,
the token, the caller, and the user are registered with the token service, and
the token is stored in a token database of the token service.

3. The method of claim 2, further comprising:
in response to receiving the token from the caller device, establishing an identity of the user using a UE private key stored in the UE;
transmitting the identity to the token service,
wherein failing to receive the communication from the token service is based on the token service failing to authenticate the identity as an identity associated with the token in the token database; and
terminating the incoming call.

4. The method of claim 2, wherein transmitting the indicated caller phone number and the token to the token service includes:
transmitting the indicated caller phone number and the token to the token service;
causing the token service to search for a registered combination of the token, the indicated caller phone number, and the user; and
based on failing to find the registered combination, causing the token service to refrain from transmitting communication to the UE.

5. The method of claim 4, wherein transmitting the indicated caller phone number and the token to the token service further includes:
based on finding the registered combination, causing the token service to:
retrieve the token from the token database,
transmit an acknowledgement (Ack) to the UE,
transmit a confirmation of retrieving the token to the caller device, and
delete the token from the token database,
the method further comprising:
receiving the Ack from the token service; and
based on receiving the Ack, indicating that the incoming call is certified.

6. The method of claim 1, wherein determining whether the indicated caller phone number associated with the incoming call is registered with the token service includes:
determining whether the indicated caller phone number is included in a local database of the UE as a registered phone number.

7. The method of claim 1, wherein transmitting, to the caller device, the indication of the UE being capable of receiving the certified call includes transmitting the indication to the caller device as a first series of dual tone multi-frequency (DTMF) tones.

8. The method of claim 7, wherein receiving the token from the caller device includes:
receiving the token as a second series of DTMF tones from the caller device; and
extracting the token from the second series of DTMF tones.

9. The method of claim 1, wherein the token includes an expiration period and is invalid after the expiration period.

10. A user equipment (UE) comprising:
one or more processors; and
memory coupled to the one or more processors, the memory storing computer-readable instructions that, when executed by the one or more processors, cause the one or more processors to perform operations, the operations comprising:
receiving an incoming call from a caller device;
determining whether an indicated caller phone number associated with the incoming call is registered with a token service;
based on determining that the indicated caller phone number is registered with the token service, transmitting, to the caller device, an indication of the UE being capable of receiving a certified call;
receiving a token from the caller device, the token including an expiration period and becoming invalid after the expiration period;
transmitting the indicated caller phone number and the token to the token service; and
based on failing to receive communication from the token service, indicating that the incoming call is uncertified.

11. The UE of claim 10, wherein:
a caller of the caller device is authenticated with the token service using a caller private key associated with the caller;
the token is generated by the caller device for a UE phone number associated with a user of the UE,
the token, the caller, and the user are registered with the token service, and
the token is stored in a token database of the token service.

12. The UE of claim 11, wherein the operations further comprise:
in response to receiving the token from the caller device, establishing an identity of the user using a UE private key stored in the UE;
transmitting the identity to the token service,
wherein failing to receive the communication from the token service is based on the token service failing to authenticate the identity as an identity associated with the token in the token database; and
terminating the incoming call.

13. The UE of claim 11, wherein transmitting the indicated caller phone number and the token to the token service includes:
transmitting the indicated caller phone number and the token to the token service;
causing the token service to search for a registered combination of the token, the indicated caller phone number, and the user; and
based on failing to find the registered combination, causing the token service to refrain from transmitting communication to the UE.

14. The UE of claim 13, wherein:
transmitting the indicated caller phone number and the token to the token service further includes, based on finding the registered combination, causing the token service to:
retrieve the token from the token database,
transmit an acknowledgement (Ack) to the UE,
transmit a confirmation of retrieving the token to the caller device, and
delete the token from the token database, and
the operations further comprise:
receiving the Ack from the token service; and
based on receiving the Ack, indicating that the incoming call is certified.

15. The UE of claim 10, wherein determining whether the indicated caller phone number associated with the incoming call is registered with the token service includes:
determining whether the indicated caller phone number is included in a local database of the UE as a registered phone number.

16. The UE of claim 10, wherein:
transmitting, to the caller device, the indication of the UE being capable of receiving the certified call includes transmitting the indication to the caller device as a first series of dual tone multi-frequency (DTMF) tones, and
receiving the token from the caller device includes:
receiving the token as a second series of DTMF tones from the caller device; and
extracting the token from the second series of DTMF tones.

17. One or more computer-readable media storing computer-readable instructions that, when executed by one or more processors, cause the one or more processors to perform operations, the operations comprising:
receiving an incoming call from a caller device;
determining whether an indicated caller phone number associated with the incoming call is registered with a token service by one of:
determining whether the indicated caller phone number is included in a local database of a user equipment (UE) as a registered phone number, or
determining whether the indicated caller phone number is included in a token database of the token service as a registered phone number;
based on determining that the indicated caller phone number is registered with the token service, transmitting, to the caller device, an indication of the UE being capable of receiving a certified call as a first series of dual tone multi-frequency (DTMF) tones;
receiving a token from the caller device as a second series of DTMF tones, the token including an expiration period and becoming invalid after the expiration period;
extracting the token from the second series of DTMF tones;
transmitting the indicated caller phone number and the token to the token service; and
based on failing to receive communication from the token service, indicating that the incoming call is uncertified.

18. The one or more computer-readable media of claim 17, wherein:
a caller of the caller device is authenticated with the token service using a caller private key associated with the caller;
the token is generated by the caller device for a UE phone number associated with a user of the UE,
the token, the caller, and the user are registered with the token service, and
the token is stored in a token database of the token service.

19. The one or more computer-readable media of claim 18, wherein the operations further comprise:
in response to receiving the token from the caller device, establishing an identity of the user using a UE private key stored in the UE;
transmitting the identity to the token service,
wherein failing to receive the communication from the token service is based on the token service failing to authenticate the identity as an identity associated with the token in the token database; and
terminating the incoming call.

20. The one or more computer-readable media of claim 18, wherein transmitting the indicated caller phone number and the token to the token service includes:
transmitting the indicated caller phone number and the token to the token service;
causing the token service to search for a registered combination of the token, the indicated caller phone number, and the user; and
based on failing to find the registered combination, causing the token service to refrain from transmitting communication to the UE.
